(19) United States
(12) Patent Application Publication
(10) Pub. No.: US 2006/0050795 A1
(43) Pub. Date: Mar. 9, 2006

(54) Joint resolution or sharpness enhancement and artifact reduction for coded digital video

(76) Inventors: Lilla Boroczky, Mount Kisco, NY (US); Yibin Yang, Pine Brook, NJ (US)

Correspondence Address: PHILIPS INTELLECTUAL PROPERTY & STANDARDS, P.O. BOX 3001, BRIARCLIFF MANOR, NY, 10510, US

(21) Appl. No.: 10/538,629

(22) PCT Filed: Nov. 28, 2003
(86) PCT No.: PCT/IB03/05536

§ 371 Date: Jun. 10, 2005

(30) Foreign Application Priority Data
Dec. 10, 2002 (US) 60432301

(51) Int. Cl. H04B 1/66

(52) U.S. Cl. 375/240.29

(57) ABSTRACT

The present application is a new approach for jointly controlling resolution or sharpness enhancement and artifact reduction in order to improve picture quality for coded digital video. The present application provides a joint control that is based on a metric, the metric being used to determine which pixel and by how much it is to be enhanced and to determine on which pixel and to what degree to carry out the artifact reduction.

### 1. FIELD OF THE INVENTION

The present invention is a new approach for joint video enhancement and artifact reduction in order to achieve optimal picture quality for coded digital video. Video enhancement may include resolution enhancement or sharpness enhancement. More particularly, the present invention is a system and method that includes sharpness enhancement or resolution enhancement, artifact reduction, and a joint control to drive both post-processing units. Most particularly, the present invention provides a joint control that is based on a metric, such as the metric provided in the inventor's co-pending patent application entitled “A Unified Metric For Digital Video Processing (UMDVP)”, the entire content of which is hereby incorporated by reference as if fully set forth herein, the metric being used to determine which pixel and by how much it is to be enhanced and to determine on which pixel and to what degree to carry out the artifact reduction.

### 2. DESCRIPTION OF THE RELATED ART

Moving Picture Expert Group (MPEG) video compression technology enables many current and emerging products, e.g., DVD players, high definition television decoders, and video conferencing, by requiring less storage and less bandwidth. Compression comes at the expense of a reduction in picture quality due to the introduction of artifacts. It is well known that such lossy compression technology (MPEG-1, MPEG-2, MPEG4, H.26x, etc.) can cause the introduction of coding artifacts that decrease picture quality of the decoded video. In block-based coding techniques the most frequent artifacts are blockiness and ringing and numerous algorithms have been developed that address reduction of these various artifacts. While the common objective of these algorithms is to reduce the artifacts without decreasing any other desirable feature of the scene content (e.g., image sharpness and fine detail). In reality, the traditional sharpness enhancement algorithms perform sub-optimally for encoded digital video, often enhancing coding artifacts already present, see inventors' co-pending patent application entitled “System and Method of Sharpness Enhancement for Coded Digital Video,” the entire content of which is hereby incorporated by reference as if fully set forth herein.

In another of the inventors' co-pending patent applications entitled “Unified Metric For Digital Video Processing,” a metric for digital video processing is defined based on MPEG coding information and local spatial features. This metric determines how much a pixel can be enhanced without boosting coding artifacts. Experiments have shown that sharpness enhancement algorithms alone combined with this metric result in better picture quality than algorithms without it. However, the video still contains coding artifacts, that need to be removed to achieve optimal picture quality.

Usually, in both de-blocking and de-ringing algorithms, the first step is to detect the artifacts, then the next steps apply artifact reduction on the localized area of the image having artifacts. If the artifact detection step is incorrect, resulting picture quality can be worse than before artifact reduction. Therefore, it is crucial to have reliable detection of coding artifacts.

It is very likely that both resolution or sharpness enhancement algorithms and artifact reduction algorithms will co-exist in a system for receipt, storage, and further processing of a priori coded digital video, e.g., MPEG coded video. Current approaches to sharpness enhancement and artifact reduction are performed independently of one another and improvements resulting from one can impact the other negatively thereby decreasing picture quality.

Thus, there is a need for a joint approach to resolution or sharpness enhancement (SE) and artifact reduction (AR) that identifies/differentiates coding artifacts and local fine details. The resolution enhancement consists of a scaling function and a sharpness enhancement algorithm. The present invention deals only with the sharpness enhancement part of the resolution enhancement. The present invention is a unified approach for joint sharpness enhancement and artifact reduction that achieves optimal picture quality for coded digital video.

Once a metric, such as UMDVP, identifies which pixel is a good candidate for enhancement and on which artifact removal has to be applied, the present invention provides a control to efficiently and reliably drive both SE and AR. In one embodiment, the present invention employs a metric to characterize the pixel containing coding artifacts such as blockiness and ringing. Then, based on the metric the control determines which and how many neighboring pixels are to be involved in AR without blurring relevant features such as edges and fine details in the vicinity of the original pixel. In addition, based on the metric the present invention determines how “aggressively” AR should be applied to a certain region or an individual pixel.

In areas that are “artifact-free”, the joint control of the present invention based on a unified metric can drive SE to enhance edges and textures in these areas such that the amount of enhancement applied can be controlled to achieve optimal picture quality.

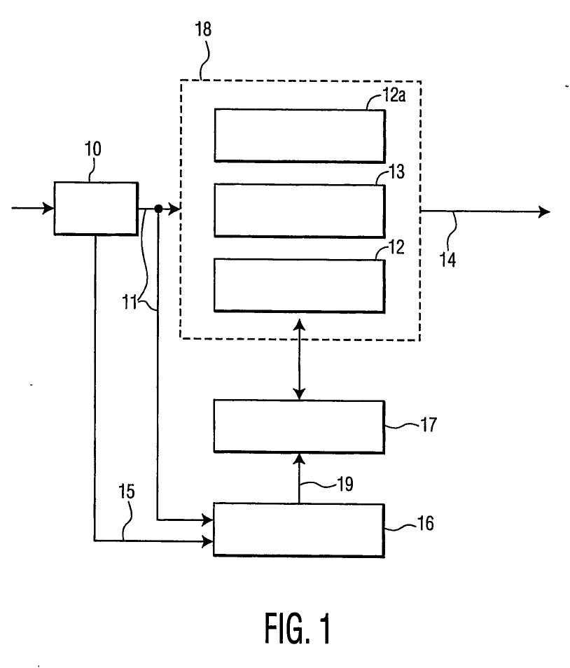

FIG. 1 illustrates a functional view of a post-processing system for a jointly controlling resolution or sharpness enhancement (SE) and artifact reduction (AR) of decoded video.

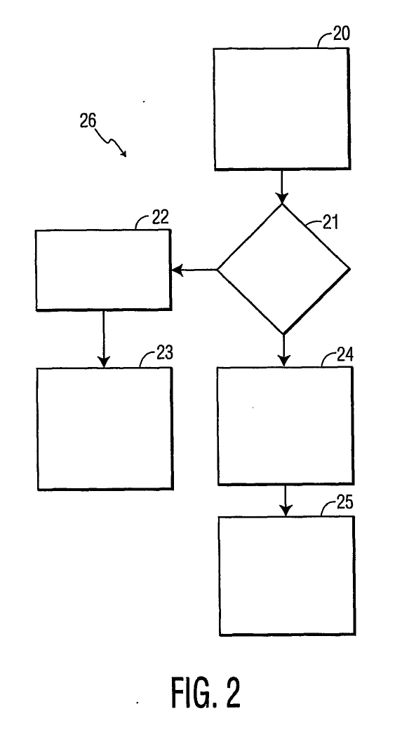

FIG. 2 illustrates a flow diagram of the control level of the post-processing method of the present invention.

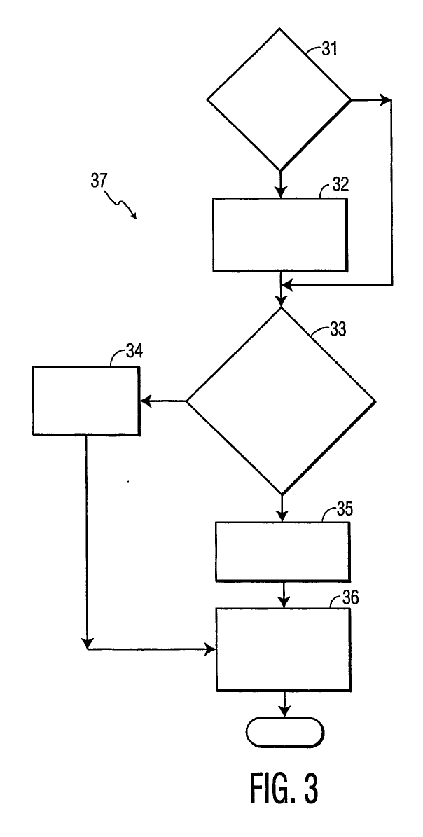

FIG. 3 illustrates a flow diagram of an algorithm level UMDVP-controlled deringing of the luminance signal.

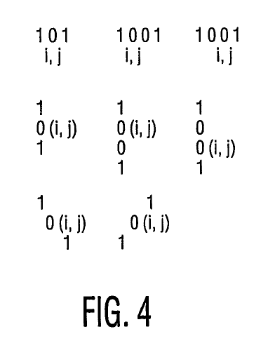

FIG. 4 illustrates the neighborhood of UMDVP values of point (i,j).

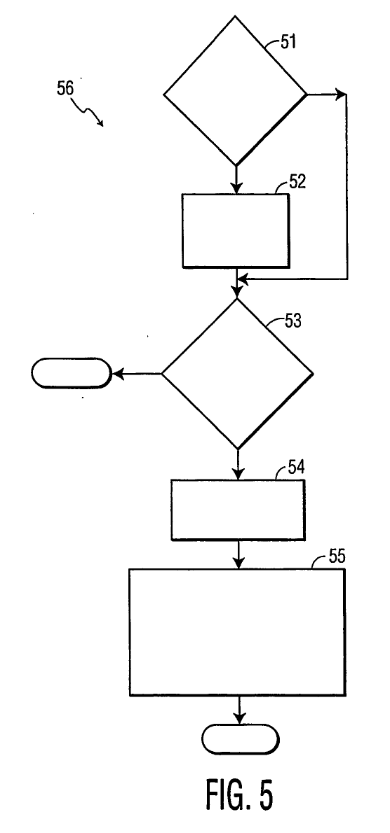

FIG. 5 illustrates a flow diagram of an algorithm level UMDVP-controlled deringing of the chrominance signal.

Referring now to FIG. 1, an MPEG-2 decoder 10 decodes an input video signal and the decoded video signal 11 is input to the post-processing unit 18. The post-processing unit 18 comprises a sharpness enhancement module 12 or resolution enhancement module 12a, and an artifact reduction module 13.

The artifact reduction module 13 comprises at least one algorithm selected from the group comprising e.g. de-blocking, de-ringing etc.

A control module 17 uses a metric 19 to jointly control the application of post-processing to the decoded video signal 11 by the sharpness enhancement module 12 and the artifact reduction module 13. The control module 17 receives the metric 19 from a metric calculation module 16. The MPEG-2 decoder 10 sends coding information 15 as well the decoded video signal 11 to the metric calculation module 16. The output of the system is the post-processed video 14.

Unified Metric for Digital Video Processing

In a preferred embodiment, the metric calculation module 16 calculates “A Unified Metric for Digital Video Processing” (UMDVP), as described in the inventors' co-pending application of the same title. From the block-based coding information 15, the UMDVP metric is calculated and reflects the local picture quality of the MPEG-2 encoded video. The UMDVP is determined based on such block-based coding information as the quantization scale, number of bits spent to code a block, and picture type (I, P or B). Such coding information is obtained from the MPEG-2 bitstream for little computational cost. The coding information is sent by the decoder to the metric calculation module . The metric calculation module 16 can adapt the UMDVP to the local scene contents using local spatial features such as local variance. The spatial features are used to refine the metric to a pixel-based value to further improve the performance of the joint post-processing unit 18.

The values of the UMDVP metric are in the range of [−1,1]. The lower the UMDVP value, the more likely the pixel is to have coding artifacts. In general, high positive UMDVP values indicate that the pixels should be sharpened and excluded from artifact reduction. The control module 17 receives the UMDVP metric 19 and uses this metric 19 to jointly control the sharpness enhancement module 12 and the artifact reduction module 13 of the post-processing unit 18. The value of metric 19 determines which of the post-processing modules is turned on, and in what order. For example, if the UMDVP metric 19 is smaller than a pre-determined threshold, VP_THRED, sharpness enhancement module 12 is turned off and artifact reduction module 18 is turned on and if UMDVP metric is greater than or equal to the threshold VP_THRED the artifact reduction module 18 is turned off and the sharpness enhancement module 12 is turned on. It is not necessary to turn off one function completely. For example, if it is determined that AR has performed well at a region with artifacts, SE can be enabled to improve the sharpness in that region)

While the UMDVP metric can indicate whether or to what degree to apply artifact reduction to a pixel, this metric does not provide a means to distinguish between different coding artifacts, such as blockiness or ringing. Thus, it is up to the artifact reduction module 13, once activated by the control module 17, to determine how to use the UMDVP metric to achieve a higher performance. For example, the value of the UMDVP metric 19 determines how “aggressively” artifact reduction or sharpness enhancement should be performed. The lower the value of the UMDVP metric below the value of VP_THRED the more artifact reduction the control unit 17 directs the artifact reduction unit 13 to perform. Otherwise, the larger the value of UMDVP is above VP_THRED the more enhancement the sharpness enhancement module 12 is directed to perform by the control unit 17.

The use of a metric in conjunction with VP THRED is illustrated in FIG. 2. The metric M=UMDVP is calculated from block-based coding information at step 20. The difference between the pre-determined threshold, VP_THRED, and the calculated metric M is determined at step 21 using the equation
AMT=M−VP_{—}THRED
The value of AMT indicates how aggressively post-processing should be applied, i.e., in direct proportion to the absolute value of AMT. When AMT is positive, artifact reduction is turned off at step 24 and enhancement is turned on at step 25 with the amount of enhancement applied over a base level being in proportion to AMT, i.e., the aggressiveness of the enhancement. If AMT is not positive, i.e., 0 or negative, enhancement is turned off at step 22 and artifact reduction is turned on at step 23. Since the lower the value of M for a given block the more likely it is that a block has artifacts, more aggressive artifact reduction is performed when it is performed in proportion to |AMT|.

Artifact Reduction Algorithms

Many types of artifacts can be introduced by lossy encoding of a video signal and can be reduced using corresponding algorithms during post-processing by the post-processing unit 18. A metric, e.g., UMDVP, can be used to control when, where and how much post-processing is accomplished by these algorithms.

Two types of artifacts that commonly occur in coded video streams are blockiness and ringing. Blockiness manifests itself as visible discontinuities at block boundaries due to the independent coding of adjacent blocks. Ringing is most evident along high contrast edges in areas of generally smooth texture and appears as ripples extending outwards from the edge. Ringing is caused by abrupt truncation of high frequency DCT components, which play significant roles in the representation of an edge.

While blockiness and remedial de-blocking have been widely studied and many de-blocking algorithms have been developed, ringing has drawn less attention. In particular, satisfactory deringing algorithms for large high-contrast high-resolution displays are not present in the prior art and those that due exist are either based on simple spatial filtering resulting in a compromised picture quality, or their computational complexity prevents any implementation in the near-term. However, ringing artifacts can be even visible at higher bit rates and are exaggerated on such displays as High-definition monitors, and are thus very annoying.

Both de-blocking and de-ringing algorithms can be controlled by the system and method of the present invention.

UMDVP-Controlled Deringing

For purposes of example and not limitation, a deringing algorithm of the artifact reduction module is presented to illustrate how an appropriate metric can be used to control a post-processing algorithm. This deringing algorithm is based on adaptive spatial filtering and employs a metric, such as UMDVP, calculated by the metric calculation unit 16, to determine the location of the filtering (detection), the size of the filter, and which pixels are included or excluded in the filter window. Further, based on the value of the metric, the deringing algorithm adaptively determines how much a filtered pixel can differ from its original values, thus providing a control over the displacement that depends on the strength of the original compression.

Ringing artifacts can occur in the chrominance components, resulting in colors that differ from the surrounding area, and, due to color sub-sampling, may spread through the entire macroblock. This problem is remedied by applying chrominance filtering in a carefully controlled way to prevent any color mismatch.

a. Deringing for the Luminance Component

By way of example and not limitation, a flow of the processing steps for a UMDVP-controlled deringing of the luminance signal is illustrated in FIG. 3. Consider a pixel located at position (i,j), where the neighborhood of position (i,j) is defined as illustrated in FIG. 4. At step 31 it is determined whether an isolated “0” UMDVP value is found in a neighborhood of UMDVP values of “1” and if so then UMDVP(i,j) is set to 1, for the pixel at location (i,j) at step 32. A neighborhood size is selected, in a preferred embodiment a 3×3 neighborhood of the pixel to be deringed, and at step 33 it is determined whether all of the UMDVP values in this neighborhood are less than or equal to “0” or if the pixel is not in a homogeneous neighborhood but has a negative UMDVP value. The condition tested at step 33 prevents performing deringing on isolated points as well as excessive blurring in, e.g., texture areas, where the UMDVP values are a mix of “1”s and “0”s.

If the condition at step 33 is satisfied, luminance values of the pixel are filtered by a first Filtering I at step 35, e.g., a low-pass filter using the chosen window size and which excludes the pixels which differ by more than a given amount, e.g., 10%, from the luminance value of the pixel being deringed. Thus, pixels with significantly different luminance values are excluded so that fine details are not filtered out instead of artifacts. Other types of filtering can be used besides low-pass, see Filtering II discussion which follows.

If the condition at step 33 is not satisfied, luminance values of the pixel are filtered by a second Filtering II step 34, which also performs as a low-pass filter:
Y_{—}filt(i,j)=Y(i,j)−f(UMDVP(i,j))*hp(i,j)
where Y(i,j) is the original luminance value, f(UMDVP(i,j)) is a function of UMDVP(i,j) and hp(i,j) is the high-pass signal. By way of example and not limitation,
f(UMDVP(i,j))=(1−UMDVP(i,j))/a
where “a” can be, e.g., 2, 4, 8, . . . . For “a”=4 the calculation of hp(i,j) can be accomplished using the following filter kernel:

$$\begin{matrix}0 & - 1 & 0 \\ - 1 & 4 & - 1 \\ 0 & - 1 & 0\end{matrix}$$

Then, the output of the filter kernel is multiplied by 0.5 to prevent very strong low-pass filtering.

After filtering, at step 36 the original values are replaced by the filtered one based on, for example and not in any limiting sense, the following definition of the maximum displacement:
Max_disp1=PAR1+PAR2 if pixel (i,j) belongs to homogenous area
Max_disp1=abs(UMDVP)*PAR1+PAR2, if not homogenous and UMDVP(i,j)<=0
Max_disp1=PAR2, otherwise,
where, for example, PAR1=30, PAR2=10.

If the absolute difference of the original luminance value and the filtered value is greater than the Max_disp1 calculated above, then either the original value will be kept or shifted only by the Max_disp1 at step 36, that is, it is set to f(Y(i,j), Y_filt(i,j), Max_disp1).

b. Deringing of the Chrominance Components

By way of example and not limitation, a flow of the processing steps for a UMDVP-controlled deringing of the chrominance signal is illustrated in FIG. 5. Consider a pixel located at position (i,j). At step 51 it is determined whether an isolated “0” UMDVP value is found in a neighborhood of UMDVP values of “1” and if so then UMDVP(i,j) is set to 1 for the pixel at location (i,j) at step 52. A neighborhood size is selected, in a preferred embodiment a 7×7 neighborhood of the pixel to be deringed, and at step 53 it is determined whether pixel (i,j) belongs to a homogeneous area. The reason a bigger window size is chosen is that in common digital video systems, the chrominance signal is sub-sampled with respect to the luminance signal, e.g., in a 422 color format the chrominance signal is sub-sampled by 2 horizontally.

If the condition at step 53 is satisfied, a low-pass filtering is applied at step 54 to the original chrominance values, i.e., in a 3×5 window to match with a 422 sub-sampling. In the filtering pixels are excluded for which chrominance values differ by more than a given amount, e.g., 10%, from the chrominance value of the pixel being deringed. Thus, pixels with significantly different chrominance values are excluded so that color mismatch is prevented.

After filtering, the original values are replaced by the filtered ones at step 55 based on, for example and not in any limiting sense, the following definition of the maximum displacement for chrominance components:
Max_disp1_chrom=(PAR1+PAR2)/4 if pixel (i,j) is belongs to homogenous area
Max_disp1_chrom=(abs(UMDVP)*PAR1+PAR2)/4, if not homogenous and UMDVP(i,j)<=0
Max_disp1_chrom=PAR2/4, otherwise,
where, for example, PAR1=30, PAR2=10.
   The max displacement for chrominance components is the same as the one used for luminance, except here it is scaled down by factor of 4 to prevent any color mismatch. The divisor is determined empirically. If the absolute difference of the original chrominance values and the filtered values is greater than the Max_disp1_chrom calculated above, then either the original values will be kept or shifted only by the Max_disp1_chrom at step 55, that is they are set to f(U(i,j), U_filt(i,j), Max_disp1_chrom) and f(V(i,j), V_filt(i,j), Max_disp1_chrom).

Sequential Control of Post-Processing

Post-processing using a metric is accomplished serially, in another preferred embodiment Metric-controlled deringing (AR) followed by metric-controlled resolution or sharpness enhancement (SE) is one such serial control that is possible using the control 17.

In view of this disclosure the various units and modules described herein can be implemented in either software or hardware or a combination of the two to achieve a desired performance level. Further, the post-processing algorithms and their parameters are included by way of example only and not in any limiting sense. Therefore, the embodiments described are illustrative of the principle of this invention for the use of a metric for the joint control of a plurality of post-processing algorithms as applied to coded digital video and are not intended to limit the invention to the specific embodiments described. In view of this disclosure, those skilled in the art can implement the apparatus comprising a control unit that uses a metric to control a post-processing unit for decoded digital video by determining the type, aggressiveness and order of post-processing algorithm application to the decoded digital video in a wide variety of ways. Further, the types of post-processing algorithms are not limited to those disclosed as examples and the post-processing algorithms themselves can make use of the metric in determining their own processing of the decoded digital video.

1. A system for post-processing of decoded digital video, comprising:
a metric calculation unit for calculation of a metric M for determining the type, aggressiveness, and order of application of a plurality of post-processing modules to the decoded digital video, the metric being based on block-based coding information obtained from the decoded digital video;
a post processing unit for improving the quality of the decoded digital video based on the metric M, comprising the plurality of post-processing modules; and
a control unit for controlling the activation of at least one post-processing module, of the plurality of post-processing modules of the post-processing unit, based on the metric M,
wherein, the quality of the decoded digital video is improved by the control unit activating, in order, at least one of the plurality of post-processing modules and the at least one activated post-processing module processing the digital video based on the metric M.

2. The system of claim 1, wherein said plurality of post-processing modules comprises at least one algorithm of each type selected from the group of types consisting of artifact reduction, sharpness enhancement, and resolution enhancement.

3. The system of claim 2, wherein the at least one artifact reduction algorithm comprises at least one of a luminance deringing algorithm based on the metric M and a chrominance deringing algorithm based on the metric M.

4. The system of claim 2, wherein the control unit further comprises a first mechanism that activates the at least one artifact reduction algorithm and turns off the at least one sharpness enhancement algorithm according to the formula:
M<VP_THRED
and turns off the at least one artifact reduction algorithm and activates the at least one sharpness enhancement algorithm, otherwise,
wherein VP_THRED is a pre-determined threshold and once activated, the algorithm determines how “aggressively” the algorithm is performed based on the value of the M metric.

5. The system of claim 2, wherein the control unit further comprises a second mechanism that determines if the algorithm that was activated performed well and if so activates the algorithm that was turned off.

6. The system of claim 4, wherein the at least one artifact reduction algorithm comprises at least one of a luminance deringing algorithm based on the metric M and a chrominance deringing algorithm based on the metric M.

7. The system of claim 4, wherein the metric M calculated is a unified metric for digital video processing (UMDVP), wherein the values of the UMDVP metric are in the range of [−1,1].

8. The system of claim 7, wherein the at least one artifact reduction algorithm comprises at least one deringing algorithm based on the metric UMDVP.

9. The system of claim 8, wherein isolated zero values of UMDVP in the neighborhood of a pixel at location (i,j) having a UMDVP value of 1, are replaced by 1 to prevent performing the deringing algorithm on an isolated pixel as well as excessive blurring for the neighborhood in which the UMDVP values are a mix of 1s and 0s, wherein a neighborhood is n×n pixels surrounding the pixel being deringed.

10. The system of claim 9, wherein:
the deringing algorithm is a luminance deringing algorithm having at least one filter, the at least one filter being adapted to—
a. select a luminance filter for the pixel at location (i,j) using a 3×3 neighborhood size, according to whether the UMDVP values indicate that the 3×3 neighborhood of the pixel at location (i,j) is homogeneous and the pixel at location (i,j) has a negative UMDVP value,
b. with the selected filter, calculate a filtered value for the luminance at pixel (i,j) based on the UMDVP value at (i,j), and
c. calculate a maximum displacement of the filtered luminance value at location (i,j) from the original luminance values at location (i,j) based at least in part on the UMDVP value at (i,j), and
d. replace the original luminance values at location (i,j) by the filtered one based on a function of the calculated maximum displacement of the filtered value from the original value.

11. The system of claim 10, wherein the filter value for the luminance at pixel(i,j) is
Y_{—}filt(i,j)=Y(i,j)−f(UMDVP(i,j))*hp(i,j)
wherein, Y(i,j) is the original luminance value, f(UMDVP(i,j)) is a function of UMDVP(i,j) and hp(i,j) is a high-pass signal.

12. The system of claim 11, wherein
f(UMDVP(i,j))=(1−UMDVP(i,j))/a
where “a” is selected from the sequence 2ⁿ=2, 4, 8, . . . for n a positive integer.

13. The system of claim 12, wherein for “a”=4 the calculation of hp(i,j) is accomplished using the following filter kernel:
$$\begin{matrix}0 & - 1 & 0 \\ - 1 & 4 & - 1 \\ 0 & - 1 & 0\end{matrix}$$
and the output of the filter kernel is multiplied by 0.5 to prevent very strong low-pass filtering.

14. The system of claim 10, wherein the function of the calculated maximum displacement is
a. Max_disp1=PAR1+PAR2 if pixel (i,j) belongs to homogenous area,
b. Max_disp1=abs(UMDVP)*PAR1+PAR2, if not homogenous and UMDVP(i,j)<=0,
c. Max_disp1=PAR2, otherwise, wherein PAR1 and PAR2 are pre-determined parameters,
d. if the absolute difference of the original luminance value and the filtered value is greater than the calculated Max_disp1, then either the original value will be kept or shifted only by the Max_disp1
Y_filt(i,j)=Y
or Y_filt=Y+Max_disp1
or Y_filt =Y−Max_disp1.

15. The system of claim 15, wherein PAR1=30 and PAR2=10.

16. The system of claim 9, wherein:
the deringing algorithm is a chrominance deringing algorithm having a filter, the filter being adapted to—
a. filter chrominance values at pixel (i,j) using a 3×5 neighborhood size, when the UMDVP values indicate that a 7×7 neighborhood of the pixel (i,j) is homogeneous,
b. calculate filtered values for the chrominance at pixel (i,j) based on low-pass filtering,
c. calculate a maximum displacement of the filtered chrominance values at location (i,j) from the original chrominance values at location (i,j) based at least in part on the UMDVP value at (i,j), and
d. replace the original chrominance values at location (i,j) by the filtered ones based on a function of the calculated maximum displacement of the filtered values from the original values.

17. The system of claim 1, wherein said control unit serially activates said post-processing modules of the plurality of post-processing modules of the post-processing unit, based on said metric.

18. The system of claim 17, wherein said post-processing modules comprise at least at least one artifact reduction algorithm and at least one of a sharpness and resolution enhancement algorithm.

19. A method for post-processing of decoded digital video to improve the quality of the decoded digital video, comprising the steps of:
providing a mechanism that calculates a metric M for determining the type, aggressiveness, and order of application of a plurality of post-processing modules to the decoded digital video, the metric being based on block-based coding information;
providing a mechanism comprising a plurality of post-processing modules that post-process the decoded digital signal to improve the quality of the decoded digital video based on said metric;
providing a control unit for the activation of at least one post-processing module, of the plurality of post-processing modules of the post-processing unit, based on said metric, calculating a metric M for controlling post-processing of each pixel of the block based on the metric; and
activating at least one of the plurality of provided post-processing modules whose selection and processing is based on the calculated metric M to improve the quality of the decoded digital.

20. The method of claim 19, wherein said step of providing a plurality of post-processing units comprises the step of providing at least one artifact reduction algorithm and at least one of a sharpness and resolution enhancement algorithm.

21. The method of claim 20, wherein the step of providing at least one artifact reduction algorithm further comprises the step of providing at least one luminance deringing algorithm based on the metric M and at least one chrominance deringing algorithm based on the metric M.

22. The method of claim 20, wherein the activating step further comprises the steps of:
providing a pre-determined threshold, VP_THRED;
if M<VP_THRED, performing the substeps of—
a. turning off the at least one sharpness enhancement algorithm, and
b. activating the at least one artifact reduction algorithm,
if M>=VP_THRED, performing the substeps of—
c. turning off the at least one artifact reduction algorithm, and
d. activating the at least one sharpness enhancement algorithm,
determining by the activated algorithm, how aggressively the algorithm is performed based on the value of the metric M.

23. The method of claim 22, wherein the step of providing at least one artifact reduction algorithm further comprises the step of providing at least one luminance deringing algorithm based on the metric M and at least one chrominance deringing algorithm based on the metric M.

24. The method of claim 23, wherein the step of calculating the metric M is further based on a mechanism that calculates M as a unified metric for digital video processing (UMDVP),
wherein, the values of the UMDVP metric are in the range of [−1,1].

25. A program product stored on a recordable medium for performing post-processing of a decoded digital video, comprising:
means for post-processing the decoded digital video based on a calculated metric;
means for calculating a metric, based on block-based coding information obtained from the decoded digital video, for determining the type, aggressiveness, and order of application of the post-processing means to the decoded digital video;
means for controlling the activation and order of activation of the post-processing means using the calculated metric.
